(19) United States
(12) Patent Application Publication
(10) Pub. No.: US 2004/0135930 A1
(43) Pub. Date: Jul. 15, 2004

(54) CASING STRUCTURE FOR REAR PROJECTION DISPLAY APPARATUS

(76) Inventors: Chun-Yao Chen, Miao- Li Hsien (TW); Chih-Chung Kang, Miao- Li Hsien (TW); Yung-Chuan Tseng, Miao- Li Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/707,625

(22) Filed: Dec. 25, 2003

(30) Foreign Application Priority Data
Jan. 13, 2003 (TW) 092200785

(51) Int. Cl. H04N 5/64

(52) U.S. Cl. 348/787

(57) ABSTRACT

A casing structure of a rear projection display apparatus includes a substrate, a rear cover and a screen frame. An electronic module and an optical module are mounted on the substrate. A bracket is mounted on a front side of the substrate. The rear cover is fixedly assembled with the substrate via a slot, a flange and a screwing element. The screen frame is mounted on a front side of the rear cover. A panel and a speaker lid cover the bracket of the substrate to accomplish the casing structure. When components inside the casing structure are to be adjusted, only the panel needs to be removed, without changing the positions of the components inside the casing structure. Thereby, adjusting time is saved.

### BACKGROUND OF INVENTION

1. Field of the Invention

The invention relates to a rear projection display apparatus, and more particularly to a casing structure for a rear projection display apparatus.

2. Description of the Prior Art

The currently projection display apparatus is divided into two subgroups: one is based on cathode ray tube (CRT) technology and the other is based on rear projection technology using an embedded optical engine. The display size of the CRT increases and thus the whole size of display apparatus is bulky, which cannot satisfy the demand of lightweight and small size. The rear projection technology is advantageous in high brightness and small size, and therefore has been applied in large-sized display apparatus for domestic appliances, domestic theater, computer games, or visual meeting.

Referring to FIG. 1, a conventional rear projection display apparatus includes a casing 1, and an optical projection system mounted inside the casing 11. The optical projection system includes an optical engine 2, a reflector 3 and a screen 4. The optical engine 2 generates image beams on the reflector 3 that reflects the light to project on the screen 4 for image display.

The path that the light from the optical engine 2 travels decides whether the image projected on the screen 2 is at its proper position. There is a production tolerance in optical components and the casing, and an accumulation tolerance in the assembly of the rear projection display apparatus. Therefore, the relative position of the optical engine 2 and the reflector 3 is required to adjust so as to correct the image and project on the screen 4 at a proper magnification power with optimal projection quality.

Referring to FIG. 2 illustrates a conventional rear projection display apparatus disclosed in Taiwan Patent No. 88120280. The rear projection display apparatus includes a lower casing 11, an upper casing 12, an optical engine 13, a reflector 14 and a screen 15. The lower casing 11 has a first opening 111 at its upper part. The upper casing 12 has a second opening 121 at its bottom. A frame 112 is mounted inside the lower casing 11 for the mount of the optical engine 13. The reflector 14 is mounted on a rear inner surface of the upper casing 12. The screen 15 is embedded at a front side of the upper casing 12. When in assembly, the optical engine 13 is mounted on the frame 112 of the lower casing 11, and then the reflector 14 and the screen 15 are mounted to the upper casing 12. Finally, the upper casing 12 snaps with a top of the lower casing 11. Thereby, an enclosed casing structure is accomplished.

When the image cannot be projected correctly onto the screen 15, the whole upper casing 12 must to be dismounted from the lower casing 11 to adjust the position of the optical engine 13. After adjustment of the optical engine 13, the upper casing 12 snaps with the lower casing 13 again to try another run. However, dismount and mount of the upper casing 12 and the lower casing 13 cause the change in the position of the reflector 14. Therefore, time needed to adjust the upper casing 12 increases. A wall surface and the frame 112 of the lower casing 11 obstruct lines of sight when the electronic components and optical components are in assembly.

Furthermore, snapping of the upper and lower casings adversely affects releasing of a mold. Therefore, an additional auxiliary design such as a sliding block is needed to assist the mold releasing. The snapping mechanism of the casing renders the assembled casing not easy to be disassembled. The snapping mechanism and the casing are formed of plastics, which tends to damage due improper mount and dismount.

### SUMMARY OF INVENTION

One object of the invention is to provide a casing structure of a rear projection display apparatus, in which a position of an optical engine relative to a reflector can be easily adjusted without moving the reflector, saving the adjusting time.

Another object of the invention is to provide a casing structure of a rear projection display apparatus, in which a screwing element is screwed in the casing for easy assembly and disassembly.

Furthermore, another object of the invention is to provide a casing structure of a rear projection display apparatus, in which a slot and a flange guide the casing in place.

In order to achieve the above and other objectives, the rear projection display apparatus of the invention includes a substrate, a rear cover and a screen frame. The substrate is used to carry a control module and an optical module of the display apparatus. The substrate has a slot and the rear cover has a flange, which correspond to each other. The rear cover includes an arc plate and two lateral plates mounted at either side of the arc plate so that a bottom of the rear cover connects to a front side of the rear cover. The rear cover is fixedly assembled with the substrate via a slot, a flange and a screwing element. The screen frame is mounted on a front side of the screen frame to seal a front side of the rear cover.

To provide a further understanding of the invention, the following detailed description illustrates embodiments and examples of the invention, this detailed description being provided only for illustration of the invention.

### BRIEF DESCRIPTION OF DRAWINGS

The drawings included herein provide a further understanding of the invention. A brief introduction of the drawings is as follows:

FIG. 1 is a schematic, cross-sectional view of a conventional rear projection display apparatus;

FIG. 2 is a cross-sectional view of another conventional rear projection display apparatus;

FIG. 3 is a perspective view of a rear projection display apparatus according to the invention;

FIG. 4 is an exploded view of a casing structure of a rear projection display apparatus according to the invention; and

FIG. 5 is a perspective view of a casing structure of a rear projection display apparatus according to the invention.

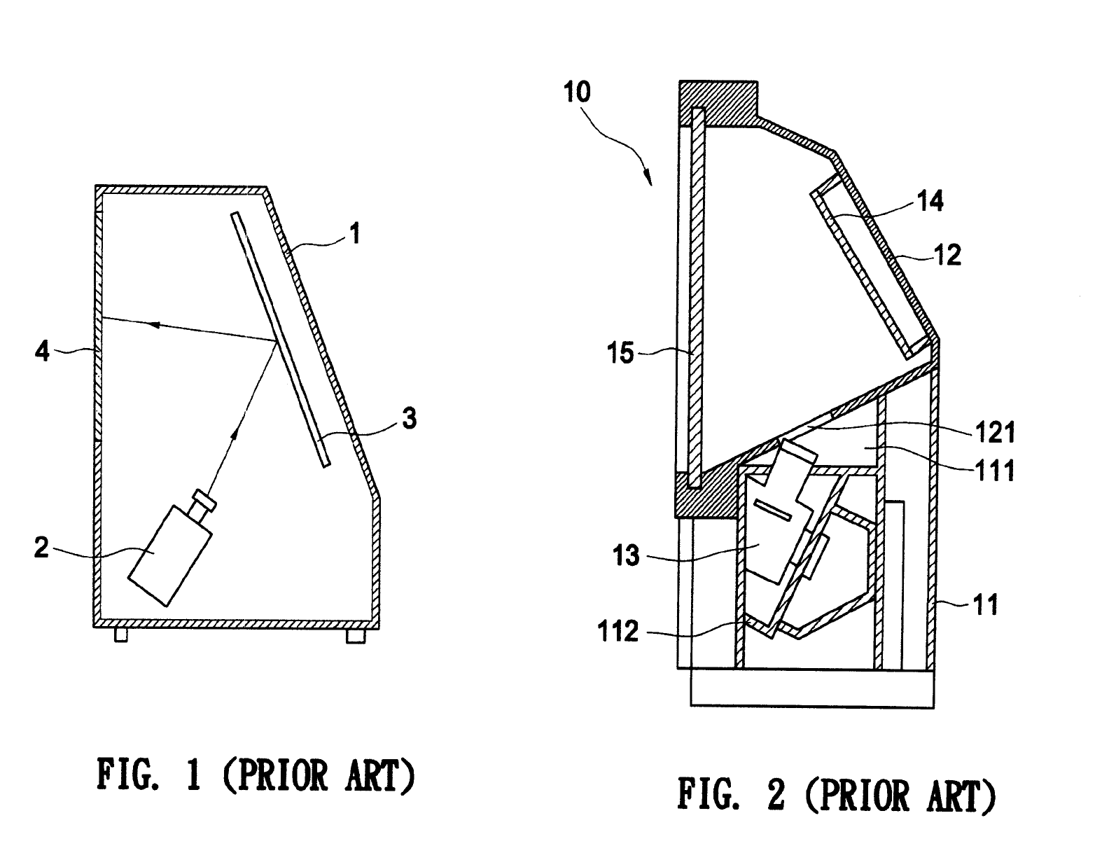

### DETAILED DESCRIPTION

Wherever possible in the following description, like reference numerals will refer to like elements and parts unless otherwise illustrated.

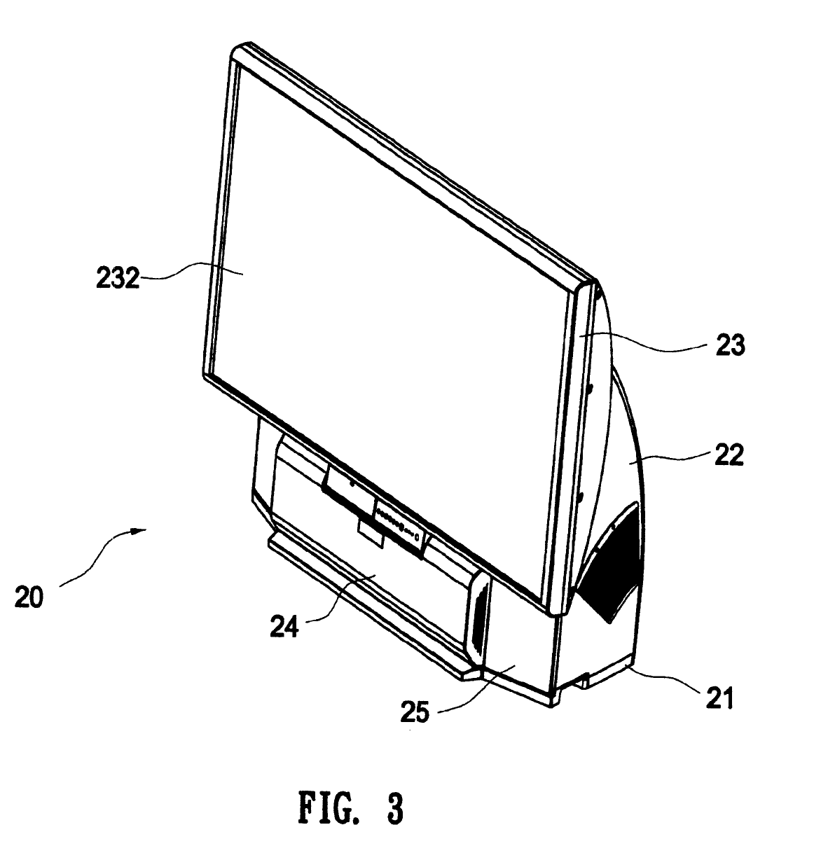

Referring to FIG. 3, a casing structure 20 of a rear projection display apparatus according to the invention includes a substrate 21, a rear cover 22 and a screen frame 23. The rear cover 22 connects to a top of the substrate 21. The screen frame 23 has a display screen 232 and is mounted onto the front side of rear cover 22. Thereby, an enclosed casing structure 20 is accomplished.

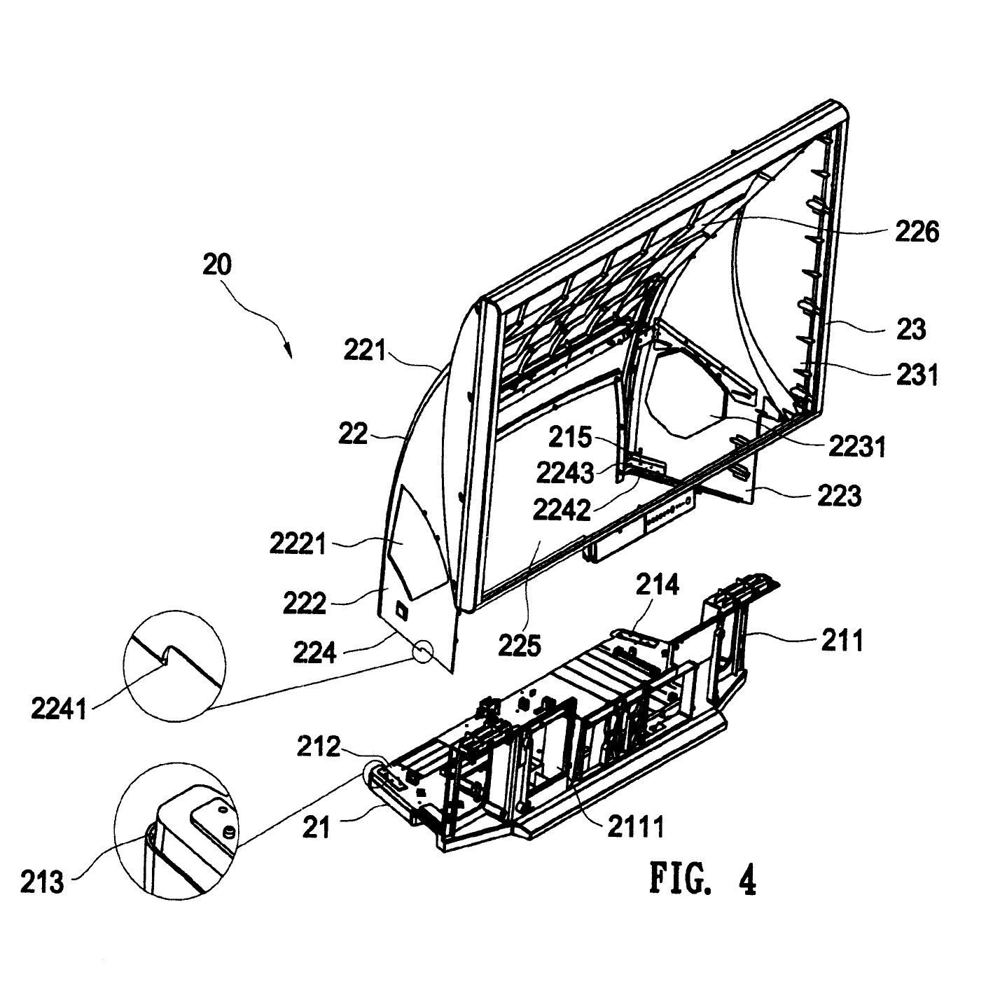

Referring to FIG. 4, a bracket 211 is vertically mounted at a front side of the substrate 21 to form a L-shaped profile. The bracket 211 is used to fix electronics such as speakers, visual signal control panel (not shown) and has at least one adjusting hole 2111. The substrate 21 has a first surface 212 for disposing an optical module (image optical module) and electronics module at a predetermined position, wherein the optical and electronics module are with a fixture or an adjusting device. The electronic optical module is, for example, a power supplier or a control module. A slot 213 is formed at each lateral side of the substrate 21 for the mount of a rear cover 22.

The rear cover 22 includes an arc plate 221, and a left lateral plate 222 and a right lateral plate 223 respectively mounted on either sides of the arc plate 221. A bottom 224 of the rear cover 22 connects to a front surface 225 of the rear cover 22. A flange 2241 extends from the bottom 224 in a manner to closely fit the slot 213 of the substrate 21 so that the rear cover 22 can be closely mounted to the substrate 21. A pair of screw pieces 2242 is vertically formed on the bottom 224. A first securing hole 2243 is formed through the rear cover 22. A second securing hole 214 is formed through the substrate 21 to correspond to the first securing hole 214. A screwing element 215 penetrates through those securing holes 2243, 214 to connect the rear cover 22 and the substrate 21. At an inner wall 226 of the rear cover 22 behind the front side 225 is mounted a reflector (not shown) to reflect image beams to the screen 232. The left lateral plate 222 and the right lateral plate 223 respectively have vent holes 2221 and 2231.

The screen frame 23 is mounted at the front side 225 of the rear cover 22. The screen frame 23 has a rectangular shape and an opening 231. A display screen 232 (as shown in FIG. 3) is mounted in the screen frame 23 to seal the opening 231.

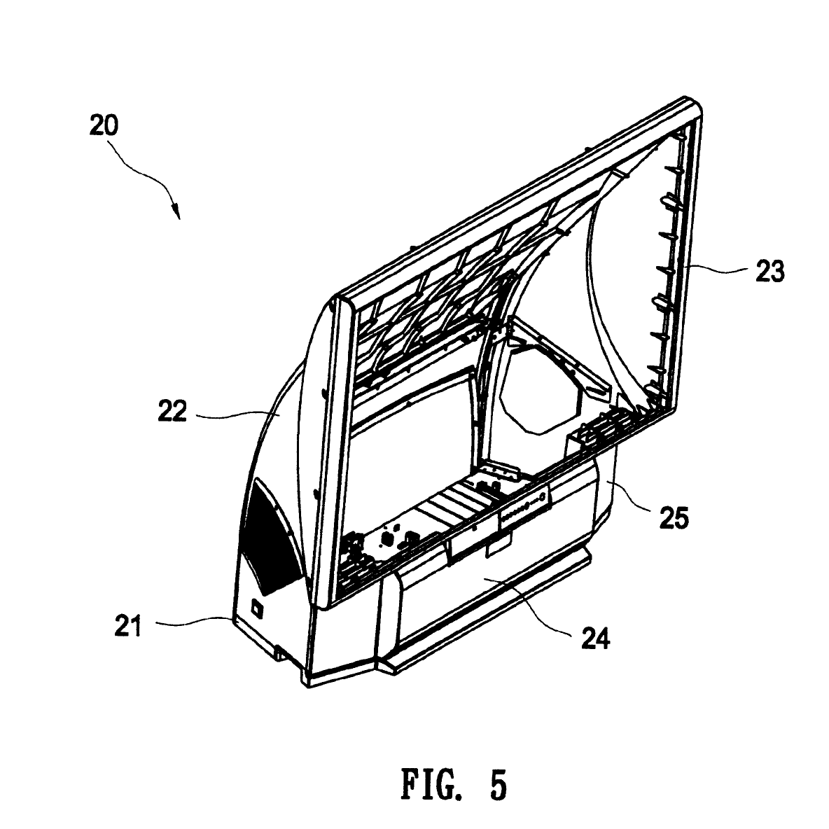

Referring to FIG. 4, in assembly, the optical module and electronic module of the projection display apparatus are mounted in place on the substrate 21. Then, the flange 2241 of the rear cover 22 aligns with the slot 213 to closely mount the bottom and the lateral side of the rear cover 22 onto the substrate 21 to form structure having a unitary back and an opened front. The screwing element 215 is screwed to fix the rear cover 22 and the substrate 21. The reflector is mounted onto the inner wall 226 of the rear cover 22 after or before the rear cover 22 is assembled. Referring to FIG. 5, after the rear cover 22 is assembled, the screen frame 23 with the display screen 232 is mounted on the front side 225 of the rear cover 22. Then, a flat-head screw is screwed thereon to enclose the front side 225 of the rear cover 22. A speaker lid 24 and a panel 25 cover the bracket 211 to accomplish the casing structure of the invention, as shown in FIG. 3. Since the mount of the elements of the casing structure is achieved by screwing elements, rather than by snapping means, there is no need in consideration of mold releasing and it is easy to dismount or mount the casing structure by screwing on or off the screwing elements.

The optical module and the electronic module of the in vention are mounted onto the substrate 21 in advance, and then the rear cover 22 is mounted. This avoids the rear cover from obstructing the line of sight when in assembly. The substrate 21 and the rear cover 22 are easily assembled via the use of the slot 213, the flange 2241 and the screwing element 215. The vent holes 2221 of the rear cover 22 can be used in moving the casing structure.

When the images cannot be projected onto the screen at a proper position, only the panel 25 needs to be dismounted to adjust the position of the optical engine relative the reflector via the adjusting hole 2111 of the bracket 211. During adjustment, the user can quickly find the correct position by watching the position of images projected on the screen.

it should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

1. A casing structure of a rear projection display apparatus, comprising:
a substrate, having a slot at a lateral side and a bracket, wherein the bracket is vertically mounted at a front side of the substrate and has at least one adjusting hole;
a rear cover, a bottom thereof connecting to the substrate,
wherein the bottom smoothly connects to a front thereof and a flange extends from the bottom thereof to correspond to the slot; and
a screen frame, mounted on the front side of the rear cover.

2. The casing structure of claim 1, wherein the substrate has a L-shaped profile.

3. The casing structure of claim 1, wherein the rear cover includes an arc plate and two lateral plates mounted at either opposite sides of the arc plate.

4. The casing structure of claim 1, wherein the electronic module and optical module of the rear projection display apparatus are mounted on the substrate.

5. The casing structure of claim 1, wherein at least one screwing piece is vertically mounted on the bottom of the rear cover, each of the screwing piece and the substrate has a securing hole corresponding to each other.

6. The casing structure of claim 1, wherein vent holes are formed at both sides of the rear cover.

7. The casing structure of claim 1, wherein a display screen is mounted on the screen frame to seal the front side of the rear cover.
